(19) United States
(12) Patent Application Publication
(10) Pub. No.: US 2002/0114082 A1
(43) Pub. Date: Aug. 22, 2002

(54) Irradiation system for generating modulated radiation

(76) Inventor: Vladimir Davydenko, Dortmund (DE)

Correspondence Address: HOFFMAN WASSON & GITLER, 2361 JEFFERSON DAVIS HIGHWAY, SUITE 522, ARLINGTON, VA, 22202

(21) Appl. No.: 10/012,356

(22) Filed: Dec. 12, 2001

(30) Foreign Application Priority Data
Dec. 16, 2000 (DE) 100 62 902.4

(51) Int. Cl. G02B 27/30; G02B 3/06; G02B 13/18

(52) U.S. Cl. 359/641; 359/710

(57) ABSTRACT

Irradiation system for generating modulated radiation comprising at least one laser (1) and at least one modulator (6), and imaging means which can image the radiation emerging from the laser (1) at least partially onto the modulator (6), the laser (1) in two directions (x, y) perpendicular to one another having a different divergence and the modulator (6) being able to effect modulation by means of at least partial diffraction of the light incident on it, the imaging means comprising a device (3) for optical beam transformation by which the divergence of the laser (1) in the first direction (x) can be interchanged with the divergence of the laser (1) in the second direction (y).

This invention relates to an irradiation system for generating modulated radiation comprising at least one laser and at least one modulator, and imaging means which can image the radiation emerging from the laser at least partially onto the modulator, the laser in two directions perpendicular to one another having a different divergence and the modulator being able to effect modulation by means of at least partial diffraction of the light incident on it.

An irradiation system of the aforementioned type is known for example from U.S. Pat. No. 5,521,748. In one of the irradiation systems described therein a laser diode bar is used with several emission centers located next to one another in the direction of the slow axis. The diffraction direction within which the modulator diffracts the light incident on it for modulation corresponds essentially to the slow axis. This is a disadvantage since the divergence of the light emerging from the laser diode bar cannot be reduced below a certain amount by the imaging means used as claimed in U.S. Pat. No. 5,521,748. This is due to the fact that as a result of several emission centers located next to one another there is multimode divergence in the direction of the slow axis.

On the other hand, it is desirable for the laser radiation incident on the modulator to have a divergence as small as possible in the plane of diffraction. Therefore the object of this invention is to devise an irradiation device of the initially mentioned type in which when used a laser diode bar divergence of the laser beam incident on the modulator is also as small as possible in the plane of diffraction of the modulator.

This is done as claimed in the invention in that the imaging means comprise a device for optical beam transformation by which the divergence of the laser in the first direction can be interchanged with the divergence of the laser in the second direction. Thus, when the laser is made as a laser diode bar with a number of emission centers which are located in the first direction essentially next to one another, in the device for optical beam transformation the divergence in the slow axis can be replaced by the divergence in the fast axis. But since the divergence in the fast axis can be collimated with suitable imaging means in a manner limited by diffraction, as claimed in the invention in the diffraction plane of the modulator very low divergence of the light incident on the modulator can be achieved. With the irradiation system as claimed in the invention it is quite possible to use high power lasers and nevertheless to make the divergence of the light incident on the modulator in the diffraction plane of the modulator so small that modulators with small diffraction angles, for example with diffraction angles less than 6°, can also be used.

To do this the imaging means can comprise for example two collimator lenses which are each located in the beam direction upstream and downstream of the device for optical beam transformation and can collimate the radiation proceeding from the laser in the second direction. Furthermore, the imaging means can comprise a Fourier lens which is located between the device for optical beam transformation and the modulator so that the laser radiation incident on it is imaged onto the modulator in the first direction.

Preferably the collimator lenses are made as cylinder lens(es) with cylinder axes in the first direction, furthermore preferably the Fourier lens being made as a cylinder lens with a cylinder axis in the second direction. With imaging means chosen in this way laser radiation in the first direction which can correspond for example to the slow axis and the second direction which can correspond for example to the fast axis can be easily focussed on the modulator.

According to one preferred embodiment of this direction, the device for optical beam transformation is formed from two arrays of refractive surfaces opposite one another. These refractive surfaces can be made as concavely toroidal surfaces or as cylinder lens surfaces. In particular, the torus axes or the cylinder axes of the refractive surfaces can be tilted against the lengthwise direction of the entry or exit surface of the device for optical beam transformation within the plane of the entry and exit surface, preferably at an angle of 45° and/or −45°. With one such device the cross section of the beam incident on the device is reflected on the plane which lies in the propagation direction, this plane assuming an angle of 45° to the first and the second direction, thus to the slow axis and the the fast axis. Thus the divergences in the slow axis direction and the fast axis direction are easily interchanged with one another.

Alternatively or in addition the device for optical beam transformation can comprise prism arrays or mirror arrays.

Other features and advantages of this invention become clear using the following description of preferred embodiments with reference to the attached drawings.

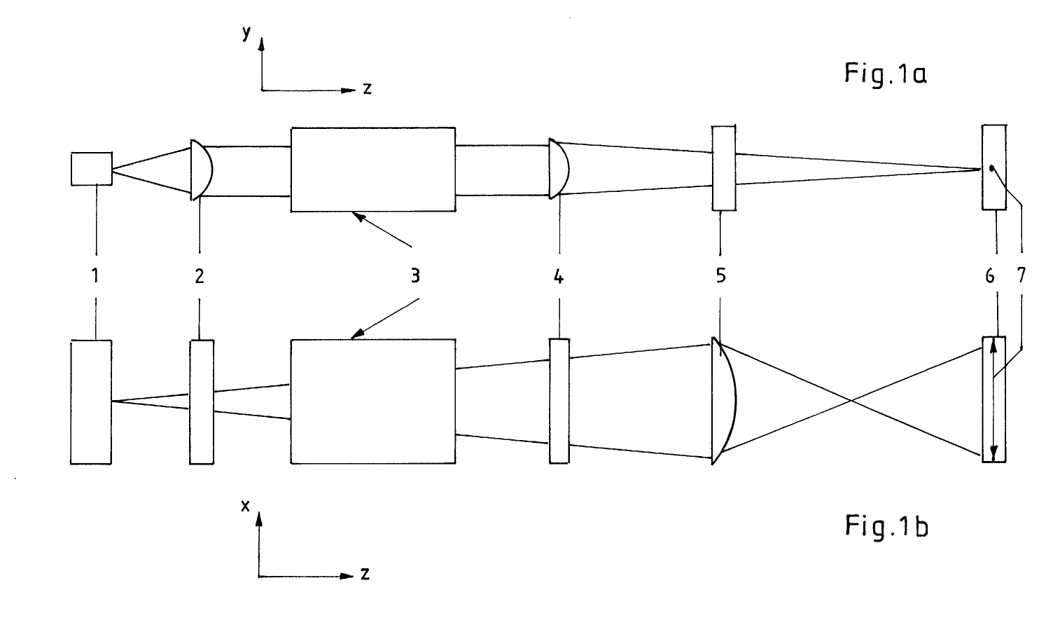

FIG. 1a shows a side view of the irradiation system as claimed in the invention;

FIG. 1b shows a plan view of the irradiation system as shown in FIG. 1a;

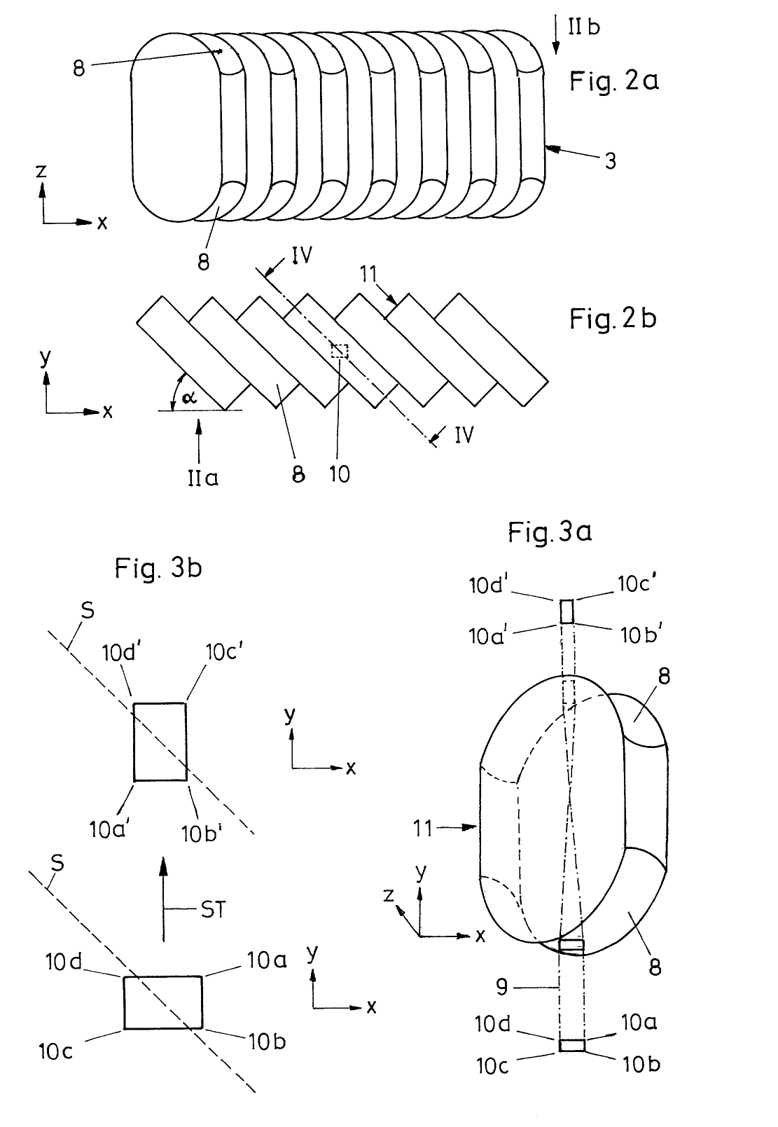

FIG. 2a shows a plan view of a device for optical beam transformation;

FIG. 2b shows a view along arrow IIb-IIb in FIG. 2a;

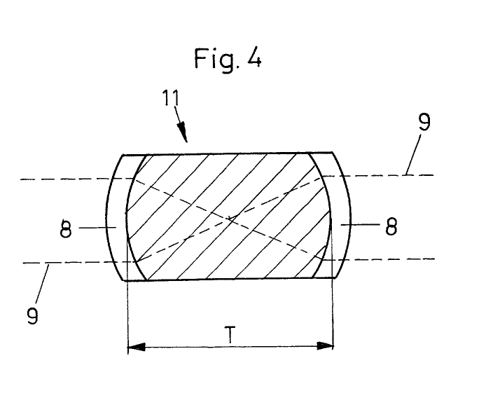

FIG. 3a shows a perspective view of a lens element of a device for optical beam transformation with a sample beam cluster;

FIG. 3b shows a schematic view of beam transformation with a lens element as shown in FIG. 3a;

FIG. 4 shows a schematic section along line IV-IV in FIG. 2b.

As is apparent from FIG. 1, an irradiation system as claimed in the invention comprises a laser 1 which is made as a laser diode bar. One such laser diode bar generally has a plurality of emission centers over its lengthwise extension which is pointed in the x-direction in FIG. 1. The divergence of the light proceeding from an individual emission center of the laser 1 in the xz plane, i.e. in the direction of the slow axis, is smaller than in the yz plane, i.e. in the fast axis. In the z direction the laser 1 is adjoined by a collimator lens 2 for the fast axis. As is apparent from FIG. 1a, in the yz plane the light emerging from the laser 1 is thus rendered parallel.

Subsequently the light in the beam direction or in the z-direction enters the device 3 for optical beam transformation, of which one example is detailed below. In the device 3 for optical beam transformation the fast axis portions of the beam cross section are interchanged with the slow axis portions, as will become clear likewise below.

After passing through the device 3 for optical beam transformation the beam passes through another collimator lens 4 for the fast axis, which provides for focussing of the light beam in the yz plane onto the modulator 6. Between the modulator 6 and the second collimator lens 4 there is a Fourier lens 5 which is likewise made like the collimator lenses 2, 4 as a cylinder lens. But in the Fourier lens 5 however the cylinder axis is aligned in the y-direction, in contrast to the collimator lenses 2, 4.

The illustrated embodiment shows only the luminous beam which emerges from one of the emission centers of the laser 1. Ultimately the Fourier lens 5 provides for this imaging onto the modulator 6 to take place in the xz plane and for the light of all emission centers of the laser diode bar to be distributed relatively uniformly over the lengthwise extension of the modulator.

In FIG. 1 the diffraction direction of the modulator 6 is labelled with reference number 7. FIG. 1 shows that the plane within which the diffraction by the modulator 6 takes place corresponds to the xz plane.

For example, depending on the triggering of the modulator 6 the zeroth or first order emerging from the modulator can be used for the irradiation for example of a print roller of a laser printer or the like.

FIG. 2 shows one possible embodiment of a device 3 for optical beam transformation, as is described for example in the German patent application 100 36 787. It is a essentially cuboidal block of transparent material on which both on the entry side and also on the exit side there is an integral number of concave toroidal refractive surfaces 8 parallel to one another. The torus axes of the refractive surfaces 8 with the base side of the cuboidal device 3 which runs in the x direction includes an angle α of 45°. In FIG. 2b the angle α corresponding to this angle α is drawn between the x direction and the lateral boundary of one of the lens elements 11 perpendicular to the torus axis. In the embodiment shown roughly ten concave toroidal refractive surfaces 8 are located next to one another on each of the two xy surfaces of the device 3. Two opposing refractive surfaces 8 at a time form a lens element 11. One each of the lens elements 11 acts essentially like a biconvex cylinder lens in which however due to the concave transverse curvature of the surface 8 for example astigmatic imaging errors can be counteracted. FIG. 4 clearly shows that the depth T of the lens elements 11 measured in the z-direction is equivalent to twice the focal length of one each of these essentially biconvex lens elements 11. This corresponds to

T−2Fₙ.

Here T is the depth of the device 3 for optical beam transformation which is made as an array of toroidal lens elements 11 and Fₙ is the focal length of one each of the lens elements 11 at a refractive index n of the selected material of the device 3. FIG. 4 shows a schematic path of a light beam 9 which illustrates that one each of the lens elements 11 converts one parallel light beam 9 in turn into one parallel light beam 9. It remains to be noted that FIG. 4 is intended to illustrate the beam path only schematically and does not represent an exact reproduction of the beam path through the illustrated geometrical device.

FIG. 3 shows the passage of a light beam 9 which is incident on the lens element 11 with a cross section 10 through a device 3 as claimed in the invention using the example of corner points 10a, b, c, d of the cross section 10. The device 3 is aligned according to the arrangement in FIG. 1 such that the refractive surfaces 8 are essentially xy surfaces.

FIG. 3a and FIG. 3b show that the cross section 10 of the light beam 9 incident on the lens element 11 corresponds to a rectangle which is extended farther in the x direction than in the y direction. After passing through the lens element 11 the cross section 10 of the light beam 9 likewise corresponds to a rectangle. But this is extended farther in the y-direction than in the x-direction.

The schematic shown especially in FIG. 3b shows that beam transformation which is illustrated by the arrow ST in FIG. 3b is done by passage of the light beam 9 through the lens element 11. The beam transformation which is undertaken by the lens element 11 corresponds to mirroring on the mirror plane S which is drawn in FIG. 3b and which runs parallel to the beam direction and is tilted by 45° both relative to the x and to the y direction. In this way, on the one hand the result is that a rectangle extending the x direction before beam transformation or a line extending beforehand in the x direction is extended in the y-direction after beam transformation.

Furthermore, the mirroring on the mirror plane S causes interchange of the sequence of corner points 10a, 10b, 10c, 10d of the cross section 10 of the beam 9 such that the corner points 10a, 10b, 10c, 10d which were ordered ascending beforehand clockwise after beam transformation are ordered ascending counterclockwise as corner points 10a′, 10b′, 10c′, 10d′, as is apparent from FIG. 3b.

Interchanging the extension in the x-direction and the extension in the y-direction by means of beam transformation prevents for example the component beams emerging from individual sections of the light source 1 from overlapping one another as a result of the divergence in the x-direction which is relatively strong under certain circumstances upstream of the device 3, since after passing through the device 3 there is only one more diffraction-limited residual divergence in the x direction, conversely the divergence in the y direction corresponds to the original divergence in the x direction of for example roughly 0.1 rad.

By the specular reflection of the cross section 10 of the beam 9 the divergences in the slow axis are interchanged with the divergences in the fast axis. This is seen in that in FIG. 3b before passage of the beam 9 through the device 3 the connecting line between the corner points 10c and 10b which corresponded to the slow axis is located in the x direction. After beam transformation or after passage through the device 3 the connecting line between 10b′ and 10c,′ is located in the y direction, conversely the connecting line between 10a and 10b which corresponds to the fast axis and which extends beforehand in the y direction is now located in the x direction as the connecting line between 10a and 10b.

This results in that in the x direction only the diffraction-limited residual divergence of the fast axis collimated by the collimator lenses 2, 4 is present. Thus the light beam 9 incident on the modulator in the diffraction direction 7 or in the diffraction plane xz has a very low divergence.

Instead of the device 3 for optical beam transformation which was described by way of example in FIGS. 2 to 4, any other devices which have a corresponding function can be used. They can be a device composed of pure cylinder lenses. But there is also the possibility of using a pair of prism arrays. Alteratively, a pair of mirror arrays can also be used. There is also the possibility of replacing the device shown in FIGS. 2 to 4 by two arrays with an identical structure corresponding to FIG. 2 which are then located at a different distance to one another. Only the property of the device 3 to interchange the divergence in the slow axis with the divergence in the fast axis is ultimately decisive.

1. Irradiation system for generating modulated radiation comprising at least one laser (1) and at least one modulator (6), and imaging means which can image the radiation emerging from the laser (1) at least partially onto the modulator (6), the laser (1) in two directions (x, y) perpendicular to one another having a different divergence and the modulator (6) being able to effect modulation by means of at least partial diffraction of the light incident on it, characterized in that the imaging means comprise a device (3) for optical beam transformation by which the divergence of the laser (1) in the first direction (x) can be interchanged with the divergence of the laser (1) in the second direction (y).

2. Irradiation system as claimed in claim 1, wherein the laser (1) is made as a laser diode bar, with a number of emission centers which are located in the first direction (x) essentially next to one another, and in the device (3) for optical beam transformation the divergence in the slow axis can be replaced by the divergence in the fast axis.

3. Irradiation system as claimed in claim 2, wherein the laser radiation incident on the modulator (6) in the diffraction plane (xz) of the modulator (6) has a divergence which corresponds to the collimated divergence of the fast axis.

4. Irradiation system as claimed in claim 1, wherein the imaging means comprise two collimator lenses (2, 4) which are each located in the beam direction upstream and downstream of the device (3) for optical beam transformation and collimate the radiation proceeding from the laser (1) in the second direction (y).

5. Irradiation system as claimed in claim 1, wherein the imaging means comprise a Fourier lens (5) which is located between the device (3) for optical beam transformation and the modulator (6) so that the laser radiation incident on it is imaged onto the modulator (6) in the first direction (x).

6. Irradiation system as claimed in claim 4, wherein the collimator lenses (2, 4) are made as cylinder lens(es) with cylinder axes in the first direction (x).

7. Irradiation system as claimed in claim 5, wherein the Fourier lens (5) is made as a cylinder lens with a cylinder axis in the second direction (y).

8. Irradiation system as claimed in claim 1, wherein the device (3) for optical beam transformation is formed from two arrays of refractive surfaces (8) opposite one another.

9. Irradiation system as claimed in claim 8, wherein the refractive surfaces (8) are made as concavely toroidal surfaces or as cylinder lens surfaces.

10. Irradiation system as claimed in claim 9, wherein the torus axes or the cylinder axes of the refractive surfaces (8) can be tilted against the lengthwise direction of the entry or exit surface of the device (3) for optical beam transformation within the plane (x, y) of the entry and exit surface, preferably at an angle (α) of 45° and/or −45°.

11. Irradiation system as claimed in claim 1, wherein the device (3) for optical beam transformation comprises prism arrays.

12. Irradiation system as claimed in claim 1, wherein the device (3) for optical beam transformation comprises mirror arrays.
